(19) United States
(12) Patent Application Publication
(10) Pub. No.: US 2012/0097807 A1
(43) Pub. Date: Apr. 26, 2012

(54) Solar panel support system

(76) Inventor: Kyle J. Rees, Toronto (CA)

(21) Appl. No.: 12/926,071

(22) Filed: Oct. 25, 2010

(51) Int. Cl. F16M 11/04

(52) U.S. Cl. 248/121

(57) ABSTRACT

A solar panel support system, having extruded thermo plastic rails, with channels formed along such rails, mounting legs of thermo plastic or metal, and attachment devices for attaching the mounting legs to the channels in the rails.

### FIELD OF THE INVENTION

The invention relates to solar panel systems, and in particular to a support system for supporting such solar panels on a surface, such as a sloping roof for example.

### BACKGROUND OF THE INVENTION

It is well understood that solar panels are usually erected either at a location on sloping surfaces or rooftops, at an angle which is hoped to be optimal with regard to the movement of the sun at the latitude of the location. It is desirable that such solar panels shall be supported on a prefabricated framework in which the framework can be first of all, fastened to the base surface whether it is a roof of a building or some other angled deck or surface. The solar panels are then attached on such framework. This raises the solar panels themselves away from the surface, so that precipitation can flow down the without interfering with the panels. In addition, electrical harnesses can be connected to the panels and supported on the framework free of contact with the deck or roof. Servicing of the panels is greatly facilitated by this system, since panels can be individually accessed, removed and replaced as desired.

In the past, such frameworks have usually consisted of a plurality of metal rails. The metal rails were secured on upright supports for example to the roof, and they were arranged in parallel lines, extending from side to side across the roof, in most cases, being spaced apart by distances appropriate to the size of the panels. The panels were then attached to the metal rails.

It has been known to provide the metal rails with various grooves and other formations to which support posts can be attached to hold them on the roof, and enabling the attachment devices to hold the solar panels to be attached to the rails.

The manufacture and installation of such metal rails constitutes a significant expense in the erection of solar panels. Generally the metal must be aluminum, to be free of corrosion, although other corrosion free metals may be used. Aluminum is also relatively easy to extrude in elongated rails. The use of aluminum represents in itself a considerable cost for the base material, and support rails made of aluminum represent a considerable weight which must be bourne on the roof. In addition, aluminum is known to be subject to weathering unless it is provided with some kind of surface finish such as anodizing. Such weathering can result in deposits of aluminum being carried off the aluminum rails by precipitation for example, and deposited on the roof. This may create unsightly streaks and patches on the surface of the roof, or even damage.

All of this is clearly undesirable, but in the past it has been more or less standard practice. An example of such metal support rails is shown in U.S. Pat. No. 6,105,316 Inventors: Bottger et al.; Granted: Aug. 22, 2000;

Clearly it is desirable to both reduce the cost of the raw material of the rails, and to reduce the weight of the rails, and to eliminate weathering, and unsightly deposits on the roof.

### BRIEF SUMMARY OF THE INVENTION

With a view to achieving these various objectives, the invention provides a solar panel support system, comprising a plurality of extruded thermo plastic rails, and a plurality of channels formed along such rails, and a plurality of mounting legs, and attachment devices for attaching the mounting legs to the channels in such rails.

Preferably, the channels will be generally of rectangular shape, and define inwardly extending channel walls defining between them a slot along the rails.

Preferably the attachment devices will be in the form of threaded attachment devices having heads with generally planar surfaces, for engaging and non rotatively locking the threaded attachment devices in the respective channels.

Preferably the attachment legs will be in the form of generally L-shaped members, having a vertical portion and a horizontal portion, and the horizontal portion being attachable to a support surface, and the vertical portion being attachable to the rails.

Preferably, there will be a plurality of attachment clips, for attaching solar panels to such rails, and the attachment brackets will comprise a generally vertical portion, a lower horizontal locking sliding portion, and an upper horizontal attachment portion, preferably the lower sliding portion will comprise the generally Tee formation having a stem, and a head transverse to the stem, and wherein the head is slidably receivable in the channels.

Preferably, the vertical portions of the attachment brackets will be of pre-determined first height, and the upper attachment portions will be located in a plane below the edge of the support rails, whereby when the attachment brackets are tightened up against the solar panels, the attachment brackets will make a frictional binding engagement within their respective channels.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective illustration of a typical solar panel installation on a sloping surface such as a roof;

FIG. 2 is a perspective illustration of a portion of a solar panel and a thermo plastic support bar, forming part of the supporting system of FIG. 1;

FIG. 3 is an exploded view of the support system, and;

FIG. 4 is a perspective of an alternate connection;

### DESCRIPTION OF A SPECIFIC EMBODIMENT

As described above, the invention seeks to provide an improved form of support system for supporting solar panels on a sloping surface such as a roof. For the purposes of this description, reference will be made to roof, although it will be understood that this is not exclusive and the sloping surface may be any form of sloping support which may be erected specifically to support solar panels themselves, or any other sloping structure.

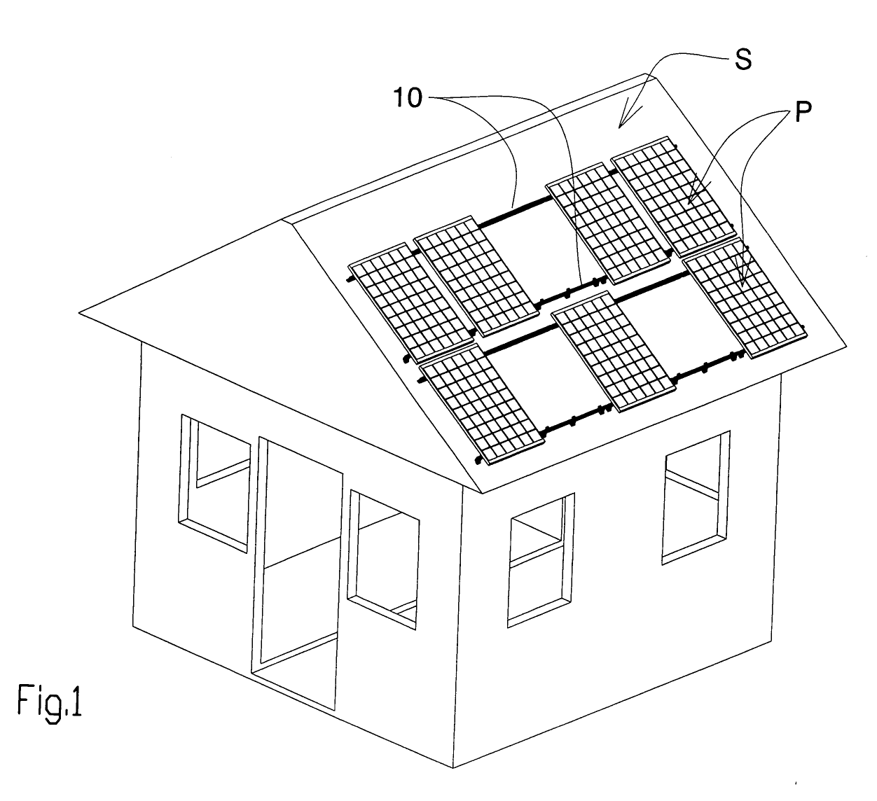

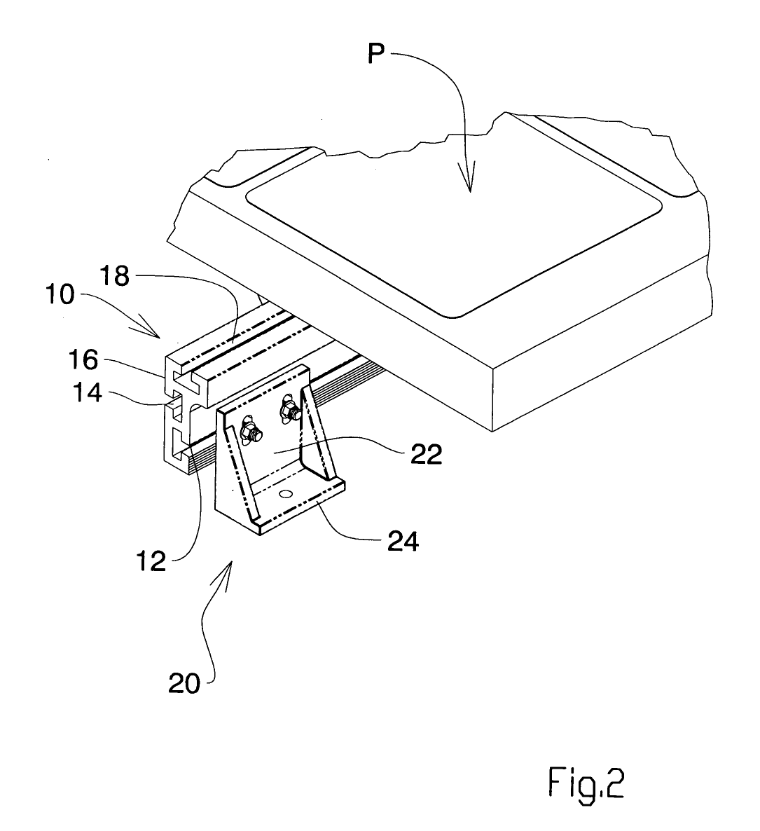

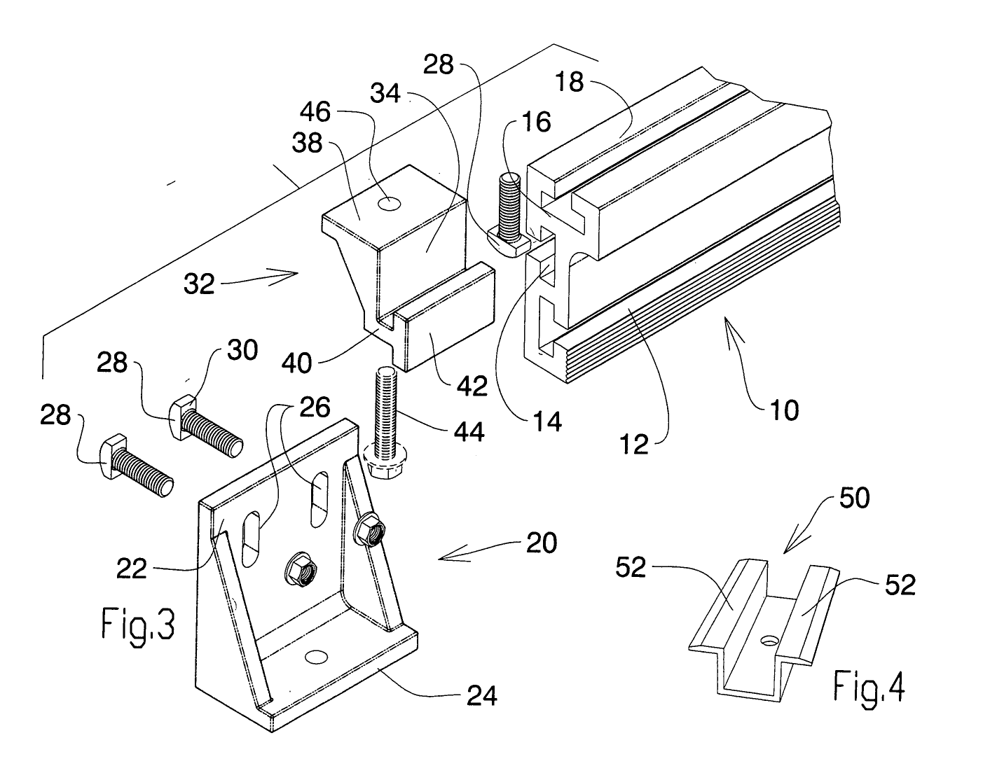

The term solar panel when used herein is used to describe any typical solar panel of which a great variety are known in the art and others which may be developed, and require no specific description. Generally speaking they are rectangular, and have a glass or plastic surface facing the sun, and a variety of solar responsive devices and circuits within the panels, for responding to the suns rays and generating electricity. As shown in FIG. 1, shows a group of solar panels (P) supported at an angle on an angled surface (S). Typically the surface (S) will be a roof of some structure. In this case it is shown as the roof of a small building or house. The invention provides a solar panel support system for such panels, having a plurality of extruded thermo plastic rails (10). The rails (10) are shown in more detail in FIGS. 2 and 3. Each of the rails (10) have a plurality of channels formed along such rails (10). A first lower channel (12) is provided on one side of a rail (10). The first channel (12) is of generally rectangular shape, having a narrow mouth, extending out to one side of rail (10).

A second channel (14) is provided on the rail (10), on the opposite side from first channel (12). Second channel (14) is of the same shape as the first channel (12) and defines a narrow open mouth.

Along the upper edge of the rail, a generally Tee-shaped formation (16) is formed. Within the T-shaped formation (16), a third channel (18) is provided. Channel (18) defines an open mouth. It will be seen that the first channel (12) extends to one side of the rail. The second channel (14) extends to the opposite side of the rail. The third channel (18) extends directed vertically upwardly.

Each of the channels (12) (14) (18) are of the same internal dimensions in this embodiment, for reasons to be described below.

In order to support the rails, there is a plurality of attachment brackets (20) provided for attaching to the first channels (12) in such rails (10).

The vertical portions (22) of the attachment brackets (20) will be of pre-determined first height, located in a plane below the edge of the support rails (10).

The attachment brackets (20) are in the form of generally L-shaped members, having a vertical portion (22) and a horizontal portion (24). The horizontal portion (24) is attachable to a support surface (S). The vertical portion (22) is attachable to the rails (10). Slots (26) are formed in portions (22).

Attachment devices are provided in the form of threaded devices having heads (28) with generally planar surfaces (30), for engaging and non rotatively holding the threaded attachment devices in the respective channels.

When the attachment devices (26) are tightened up, the attachment brackets (20) will make a frictional binding engagement within their respective channels.

In order to attach the solar panels (p) to the rails (10) there are a plurality of attachment slides (32), for attaching solar panels (p) to such rails (10). The attachment slides (32) comprise a generally vertical portion (34), and an upper horizontal attachment portion (38). A lower sliding portion comprises a generally Tee-formation having a stem (40), and a head (42) transverse to the stem (40). The head (42) is slidably receivable in the second channels (14).

In many cases, the solar panels (p) will be provided with a plurality of threaded recesses (not shown). Bolts (44) will be provided for passing through holes (46) in attachment slides (32) and securing them on the underside of the solar panels (p).

By tightening up the bolts against the solar panels, the solar panels will be drawn down firmly against the upper surface of the Tee-shaped portion (16) of the rail (10) and this will have the effect of binding the stem (40) and head (42) of the attachment slides within its corresponding second channel (14).

It will be appreciated that the dimension of the vertical portion (34) of the attachment slides will be slightly less that the distance from the second channel (14) to the upper surface of the Tee-shaped portion (16) of the rail (10).

This will ensure that the bolt (44) may be tightened up, this causing the stem (40) and head (42) to bind in the second channel (14).

In some cases however, it may be desirable to use solar panels without such threaded recesses. In this case, a separate attachment channel (50), shown in FIG. 4 may be used. The attachment channel (50) will be of generally hat-shape in section, and provide two locking flanges (52), for engaging the edges of solar panels on either side. Such hat-shaped attachments may be attached to the third channel (18) of the rail, by threaded fastenings such as bolt (26).

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A solar panel support system, comprising:
a plurality of extruded thermo plastic rails;
a plurality of channels formed along such rails;
a plurality of mounting legs of material selected from thermo plastics or metals, and attachment devices for attaching said mounting legs to said channels in said rails.

2. A solar panel support system as claimed in claim 1: wherein
the channels are generally of rectangular shape, and define inwardly extending channel walls defining between them a slot along the rails.

3. A solar panel support system as claimed in claim 1: wherein
the attachment devices are in the form of threaded attachment devices having heads with generally planar surfaces, for engaging and non rotatively holding the threaded attachment devices in the respective channels.

4. A solar panel support system as claimed in claim 1: wherein
the attachment legs are in the form of generally L-shaped members, having a vertical portion and a horizontal portion, and the horizontal portion being attachable to a support surface, and the vertical portion being attachable to the rails.

5. A solar panel support system as claimed in claim 1: and including a plurality of attachment brackets, for attaching solar panels to such rails, wherein the attachment brackets comprise a generally vertical portion, a lower horizontal locking sliding portion, and an upper horizontal attachment portion, and wherein the lower sliding portion comprises the generally Tee shaped formation having a stem, and a head transverse to the stem, and wherein the head is slidably receivable in the channels.

6. A solar panel support system as claimed in claim 5: wherein the vertical portions of the attachment brackets will be of pre-determined first height, and the upper attachment portions will be located in a plane below the edge of the support rails, whereby when the attachment brackets are tightened up against the solar panels, the attachment brackets will make a frictional binding engagement within their respective channels.
